(19) United States
(12) Patent Application Publication
(10) Pub. No.: US 2025/0384275 A1
(43) Pub. Date: Dec. 18, 2025

(54) TRAINING METHOD, TRAINING SYSTEM AND NON-TRANSITORY COMPUTER-READABLE MEDIA

(71) Applicants: HON HAI PRECISION INDUSTRY CO., LTD., New Taipei City (TW); Foxconn Technology Group Co., Ltd., Guangdong Province (CN)

(72) Inventors: Yung-Hui LI, New Taipei City (TW); Yi-Rong LIN, New Taipei City (TW); Nien-Yi JAN, New Taipei City (TW); Kai-Lin YANG, New Taipei City (TW); Meng XU, New Taipei City (TW); Jianping WANG, New Taipei City (TW)

(21) Appl. No.: 19/241,395

(22) Filed: Jun. 18, 2025

Related U.S. Application Data
(60) Provisional application No. 63/661,051, filed on Jun. 18, 2024.

(51) Int. Cl. G06N 3/082; G06N 3/0495

(52) U.S. Cl. CPC G06N 3/082; G06N 3/0495

(57) ABSTRACT

A training method includes the following steps for each time step included in one or more episode. An action is generated by a sparse agent according a state. Candidate samples are obtained from an experience replay buffer, to update a current neural network of the sparse agent. The step for updating the current neural network includes the following steps. A loss function is calculated according to the candidate samples. Gradients of the loss function with respect to weights are calculated. Perform gradient clipping on the gradients to generate adjusted gradients. Perform sharpness awareness minimizes (SAM) calculation on the adjusted gradients to obtain perturbation vectors. Update the current neural network according to the loss function and the perturbation vectors to output an updated neural network.

### CROSS-REFERENCE TO RELATED APPLICATION

This application claims priority to U.S. Provisional Application Ser. No. 63/661,051, filed Jun. 18, 2024, which is herein incorporated by reference in its entirety.

### BACKGROUND

### Field of Invention

The present invention relates to a training method and training system. More particularly, the present invention relates to a training method, training system and non-transitory computer-readable media for lifelong deep reinforcement learning.

### Description of Related Art

In reinforcement learning, achieving effective generalization is crucial for adapting models to different tasks while retaining previous knowledge. That is, rapidly learning new tasks without losing prior knowledge poses a challenge. Therefore, lifelong deep reinforcement learning (DRL) approaches are proposed. The lifelong DRL approaches, such as, regularization-based, replay-based, and expansion-based models, aim to address this issue by effectively adapting to new tasks while preserving earlier knowledge.

Despite the significant progress achieved, current lifelog DRL methods employ model architecture extension or continuous knowledge memory in the replay buffer, leading to increased resource consumption as more task are learned. For example, the model size of the state-of the art lifelong DRL method increases proportionally with the number of tasks. If the number of task exceeds 100, the model size required will increase by a factor of 100. In these cases, there is a pressing demand for a lightweight solution for lifelong DRL approaches. Therefore, how to provide a lifelog deep reinforcement learning method to solve the above problems is an important issue in this field.

### SUMMARY

The present disclosure provides a training method. In each time step in one or more episode, the training method includes the flowing steps. A sparse agent generates an action according to a state. A plurality of candidate samples are obtained from an experience replay buffer to update a current neural network of the sparse agent. The step of updating a current neural network includes. A loss function is calculated according to the candidate samples. A plurality of gradients of the loss function with respect to a plurality of weights are calculated. Gradient clipping is performed on the gradients to generate a plurality of adjusted gradients. Sharpness awareness minimization calculation is performed according to the adjusted gradients, to obtain a plurality of perturbation vectors. The current neural network is updated according to the loss function and the perturbation vectors, to generate an updated neural network.

The present disclosure provides a training system. The training system includes a memory device and a processing circuitry. The memory device is configured to store a plurality of instructions and data. The processing circuitry is configured to access the memory device to execute following steps in one or more episode. A current action is generated, by a sparse agent, according to a current state. Obtain a plurality of candidate samples from an experience replay buffer to update a current neural network of the sparse agent. The processing circuitry is further configured to execute following steps in step of updating a current neural network. Calculate a loss function according to the candidate samples. Calculate a plurality of gradients of the loss function with respect to a plurality of weights. Perform gradient clipping on the gradients to generate a plurality of gradients. Perform sharpness awareness minimization calculation according to the adjusted gradients, to obtain a plurality of perturbation vectors. Update the current neural network according to the loss function and the perturbation vectors, to generate an updated neural network.

The present disclosure provides a non-transitory computer-readable media, comprising a plurality of instructions and data accessed by a processing circuitry to execute. A current action is generated, by a sparse agent, according to a current state. Obtain a plurality of candidate samples from an experience replay buffer to update a current neural network of the sparse agent. Step of updating the current neural network includes following steps. Calculate a loss function according to the candidate samples. Calculate a plurality of gradients of the loss function with respect to a plurality of weights. Perform gradient clipping on the gradients to generate a plurality of gradients. Perform sharpness awareness minimization calculation according to the adjusted gradients, to obtain a plurality of perturbation vectors. Update the current neural network according to the loss function and the perturbation vectors, to generate an updated neural network.

Summary, the training method of the present disclosure utilizes sharpness awareness minimization calculation to improve the generalization ability. Furthermore, the present disclosure includes the gradient clipping operation before the sharpness awareness minimization calculation, which can avoid a gradient explosion occurs in sharpness awareness minimization calculation due to the variances between tasks.

### BRIEF DESCRIPTION OF THE DRAWINGS

The present disclosure can be more fully understood by reading the following detailed description of the embodiment, with reference made to the accompanying drawings as follows.

FIG. 1 depicts a schematic diagram of learning architecture of a lifelong deep reinforcement learning model according to some embodiments of the present disclosure.

FIG. 2A and FIG. 2B depict schematic diagrams of a training method according to some embodiments of the present disclosure.

FIG. 3A and FIG. 3B depict schematic diagrams of a lifelong deep reinforcement learning model updated in each time step according to some embodiments of the present disclosure.

FIG. 4 depicts a schematic diagram of a training system according to some embodiments of the present disclosure.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. Description of the operation does not intend to limit the operation sequence. Any structures resulting from recombination of elements with equivalent effects are within the scope of the present disclosure. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

In the description herein and throughout the claims that follow, unless otherwise defined, all terms have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In the description herein and throughout the claims that follow, the terms “comprise” or “comprising,” “include” or “including,” “have” or “having,” “contain” or “containing” and the like used herein are to be understood to be open-ended, i.e., to mean including but not limited to.

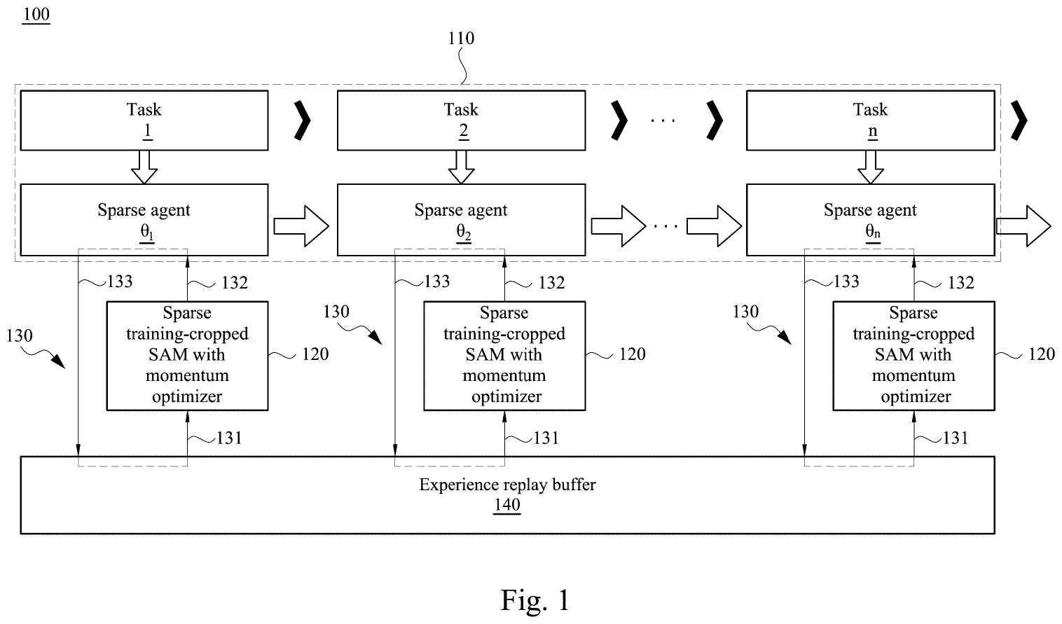

A description is provided with reference to FIG. 1. FIG. 1 depicts a schematic diagram of learning architecture of a lifelong deep reinforcement learning model 100 according to some embodiments of the present disclosure. As shown in FIG. 1, the reinforcement learning model 100 includes a lifelong in learning architecture 110, a sparse training-cropped sharpness awareness minimize (SAM) with momentum optimizer 120 and an experience replay buffer 140. In some embodiments, the lifelong learning architecture 110 includes sparse agents θ₁˜θₙ respectively executes tasks 1˜n. In some embodiments, the lifelong learning architecture 110 includes the sparse agents θ₁˜θₙ with modular and combination characteristics. In some embodiments, each goal can be separated into a set of tasks. If different goals share the same task, the same sparse agent can be utilized to learn and/or solve. In some embodiments, when the lifelong learning architecture 110 faces to a task (such as, the task 1), it is only update the sparse agent (such as, the sparse agent θ₁) corresponding to the task, and the remaining sparse agents (such as, the sparse agents θ₂˜θₙ) are not change.

To reduce the model size, the reinforcement learning model 100 adopts sparse training method. In particular, the dynamic sparse training method is used to implement the lightweight model of the deep reinforcement training. In some embodiments, the sparse agents θ₁˜θₙ respectively include neural network models for execute tasks 1˜n. In some embodiments, sparse agent refers to an agent use a sparse model to learn and interact with an environment. In some embodiments, a portion of nodes included in the neural network model of each of the sparse agents θ₁˜θₙ are removed or masked, such that the neural network model of each of the sparse agents θ₁˜θₙ has sparse weight. In some embodiments, a ratio of the removed or masked weight of the neural network model of each of the sparse agents θ₁˜θₙ to all the weight is referred to a sparsity ratio, where the sparsity ratio can be a value larger than 0% and less than 100%. In some embodiments, the sparsity ratio of the reinforcement learning model of each of the sparse agent θ₁˜θₙ can reaches 90%. As a result, the computational complexity and consumption resource can be greatly reduced.

However, directly applying the sparse training to the lifelong deep reinforcement training can result in the unintentional removal of weights containing important previous experience, worsening catastrophic forgetting and limiting the model's ability to generalize to new tasks. To improve the generalization ability, the present disclosure develops a new gradient optimization method, referred to as sparse training-cropped sharpness awareness minimize with momentum (ST-CSAMM) optimizer, which is referred as sparse training-cropped SAM with momentum optimizer or ST-CSAMM optimizer.

In some embodiments, the sparse training-cropped SAM with momentum optimizer 120 includes a cropped SAM unit, a momentum unit, an updating unit and a pruning and growing unit. In some embodiments, the cropped SAM unit is able to enhance the robustness of the model and reduce the loss sharpness in the parameter space. In some embodiments, the cropped SAM unit can avoid a gradient explosion occurs in sharpness awareness minimization calculation due to the variances between tasks. In some embodiments, the momentum unit is configured to consider the update to the weight in a prior time step, in order to speed up the training of the model to achieve the optimal model. In some embodiments, the pruning and growing unit is configured to prune a portion of the weights and grow the same number weights according to the calculated loss of the samples obtained from the experience replay buffer 140, in order to avoid pruning the weights containing important previous experiences, thereby mitigating catastrophic forgetting.

In some embodiments, the sparse agent θ₁ is configured to interacts with the environment and the sparse agent θ₁ updates an neural network by the ST-CSAMM optimizer 120 according to the samples obtained from the experience replay buffer 140 in one or more episode, in order to execute a task 1. That is, in one or more episode for executing the task 1, the sparse agent θ₁ is updated by ST-CSAMM optimizer 120. Specifically, in one or more episode for executing the task 1, the loop 130 is performed, and the said loop 130 included a sampling operation 131 for sampling samples from the experience replay buffer 140, an updating operation 132 for updating the neural network in the parse agent θ₁ by the ST-CSAMM optimizer 120 and a storing operation 133 for storing the updated neural network of the sparse agent θ₁ in the experience replay buffer 140.

In some embodiments, when there is a new task (such as, a task 2 different from the task 1) assigned, the sparse agent θ₁ can be duplicated as a sparse agent θ₂. In some embodiments, the sparse agent θ₂ is configured to interacts with the environment and the sparse agent θ₂ updates an neural network by the ST-CSAMM optimizer 120 according to the samples obtained from the experience replay buffer 140 in one or more episode, in order to execute a task 2. That is, in one or more episode for executing the task 2, the sparse agent θ₂ is updated by ST-CSAMM optimizer 120. In some embodiments, in one or more episode for executing the task 2, the updating of the sparse agent θ₂ is similar with the updating of the sparse agent θ₁, and the description is omitted here.

As a result, under the lifelong learning architecture 110, when a new task (such as, a task n) assigned, the sparse agent θₙ is configured to interacts with the environment and the sparse agent On updates an neural network by the ST-CSAMM optimizer 120 according to the samples obtained from the experience replay buffer 140 in one or more episode, in order to execute a task n. That is, in one or more episode for executing the task n, the sparse agent On is updated by ST-CSAMM optimizer 120. In some embodiments, in one or more episode for executing the task n, the updating of the sparse agent On is similar with the updating of the sparse agent θ₁, and the description is omitted here.

In some embodiments, the experience replay buffer 140 can store n sparse agents θ₁˜θₙ to respectively execute the multiple task (such as, tasks 1˜n), where the number can be 50, 100, 150, 200 or other numbers. In this case, since each of the sparse agents θ₁˜θₙ has a neural network model, it will significantly reduce the computation resource.

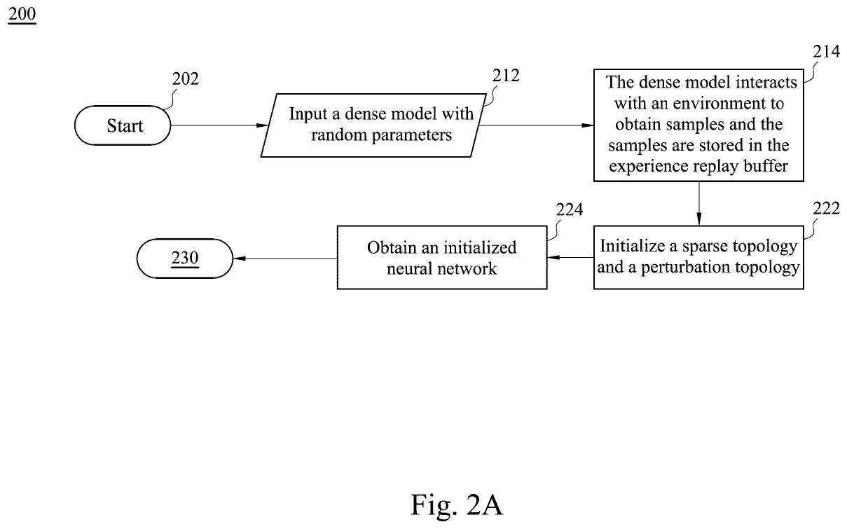

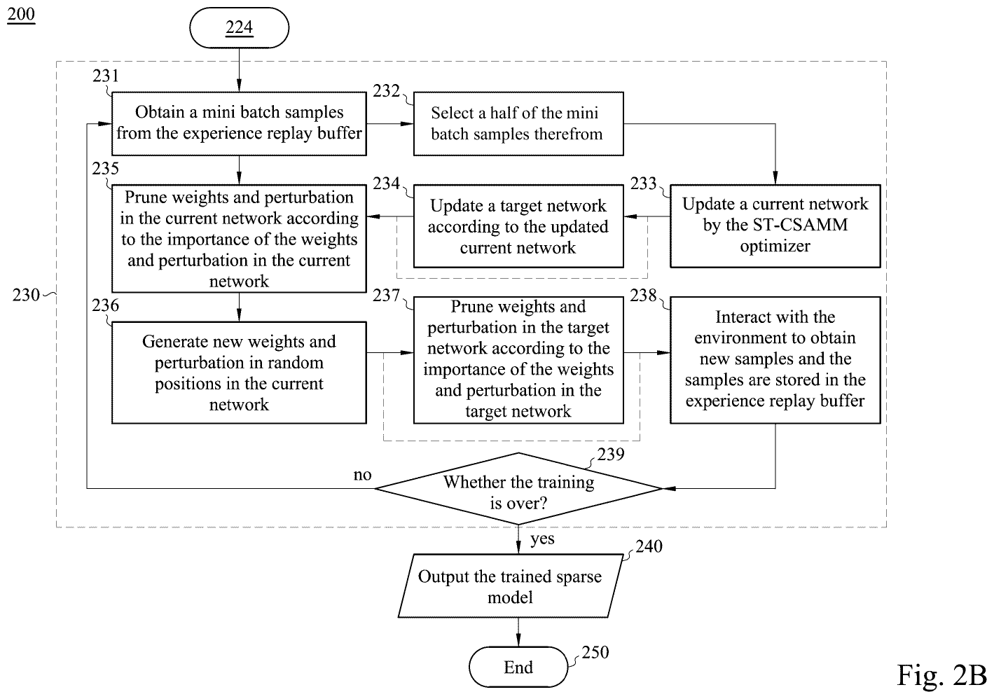

A description is provided with reference to FIG. 2A and FIG. 2B. FIG. 2A and FIG. 2B depict schematic diagrams of a training method 200 according to some embodiments of the present disclosure. In some embodiments, the training method 200 is a sparse training method. In some embodiments, the training method 200 is a dynamic sparse training method. In some embodiments, the training method 200 can be a learning method. In some embodiments, the training method 200 can be a lifelong reinforcement learning method. In some embodiments, the training method 200 includes steps 202, 212, 214, 222, 224, 230, 240 and 250.

Step 202 is executed to start performing a training method 200.

Step 212 is executed to input a dense model with random parameters. In some embodiments, the dense model includes neurons and connection relationship between the neurons included in each of a current neural network and a target neural network. The current neural network and the target neural network are respectively referred to the current network and the target network in the following description.

In Step 214, an agent with the dense model interacts with an environment to obtain samples, and stores the samples in the experience replay buffer. In some embodiments, the agent with the dense model can randomly interacts with the environment to generate a certain number of samples, and each of the said samples includes a state, an action, a reward and a next sate.

Step 222 is executed to initializing a sparse topology and a perturbation topology. In some embodiments, the sparse topology can be implemented by a mask of the weights, and the perturbation topology can be implemented by a mask of the perturbation. In some embodiments, the initialization for the sparse topology and the perturbation topology can randomly mask a certain proportion of the weights and the perturbation vectors based on the sparsity ratio to obtain an initialized neural network.

Step 224 is executed to obtain an initialized neural network. In some embodiments, the initialized neural network includes a current network and a target network. In some embodiments, the current network is generated according to the dense model, the sparse topology and the perturbation topology. In some embodiments, the target network is generated according to the dense model, the sparse topology and the perturbation topology. In some embodiments, each of the current network and the target network is a sparse neural network including neurons, weights, the sparse topology and the perturbation topology. In some embodiments, an agent with a sparse neural network is considered as a sparse agent.

Step 230 is executed to update the neural networks included in the sparse agent. In some embodiments, step 230 corresponds to the loop 130 in FIG. 1. In some embodiments, step 230 includes steps 231˜239.

Step 231 is executed to obtain mini batch samples from the experience replay buffer.

Step 232 is executed to select a half of the mini batch samples therefrom.

Step 233 is executed to update a current network by the ST-CSAMM optimizer.

Step 234 is executed to update a target network according to the updated current network.

Step 235 is executed to prune weights and perturbation in the current network according to the importance of the weights and perturbation in the current network.

Step 236 is executed to generate new weights and perturbation in random positions in the current network.

Step 237 is executed to prune weights and perturbation in the target network according to the importance of the weights and perturbation in the target network. In some embodiments, step 237 further includes an operation of generating new weights and perturbation in random positions in the current network.

Step 238 is executed to interact with the environment to obtain new samples and the samples are stored in the experience replay buffer.

Step 239 is executed to determine whether the training is over? If YES, step 240 is executed. If NO, step 231 is executed. In some embodiments, whether the training is over can be determined by considering whether time steps in one or more episode of a task are completed. In the other embodiments, whether the training is over can be determined by a predetermined period.

Step 240 is executed to output trained sparse model.

Step 250 is executed to end the episode.

In some embodiments, the current network updates the target network every M steps, the said M can be any positive integer. That is, steps 234 and 237 can be omitted in certain time steps in one episode.

Although the present disclosure illustrates the method as steps or events in series, it should be understood that, the orders of the steps or the events should not be limited thereto. For example, some steps can occur in different orders and/or occur with other steps or events not illustrates in the present disclosure. Also, when implementing one or more embodiments disclosed in the present disclosure, not all of the steps are necessary. In addition, one or more steps can be performed in one or more separated steps or phrases.

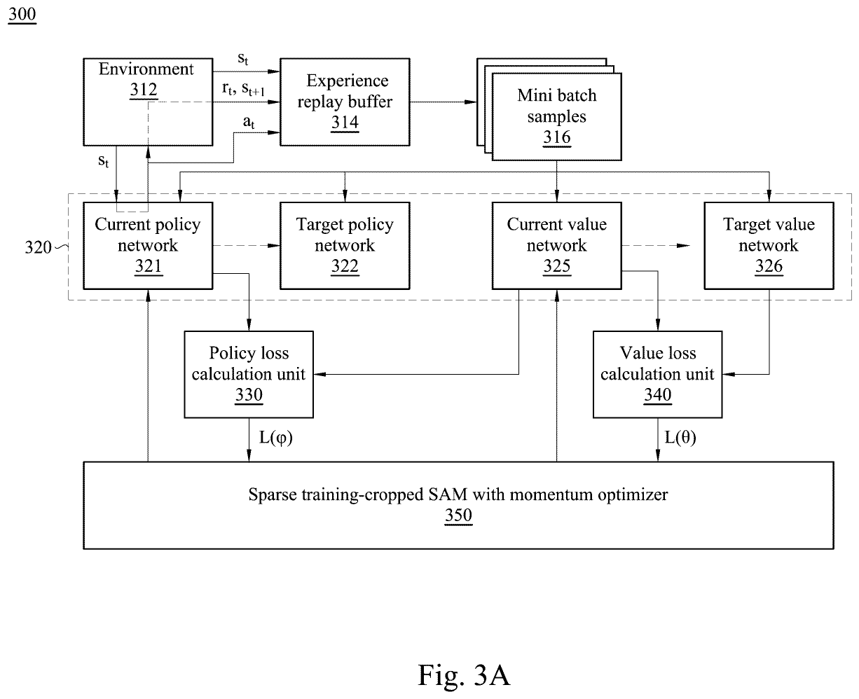

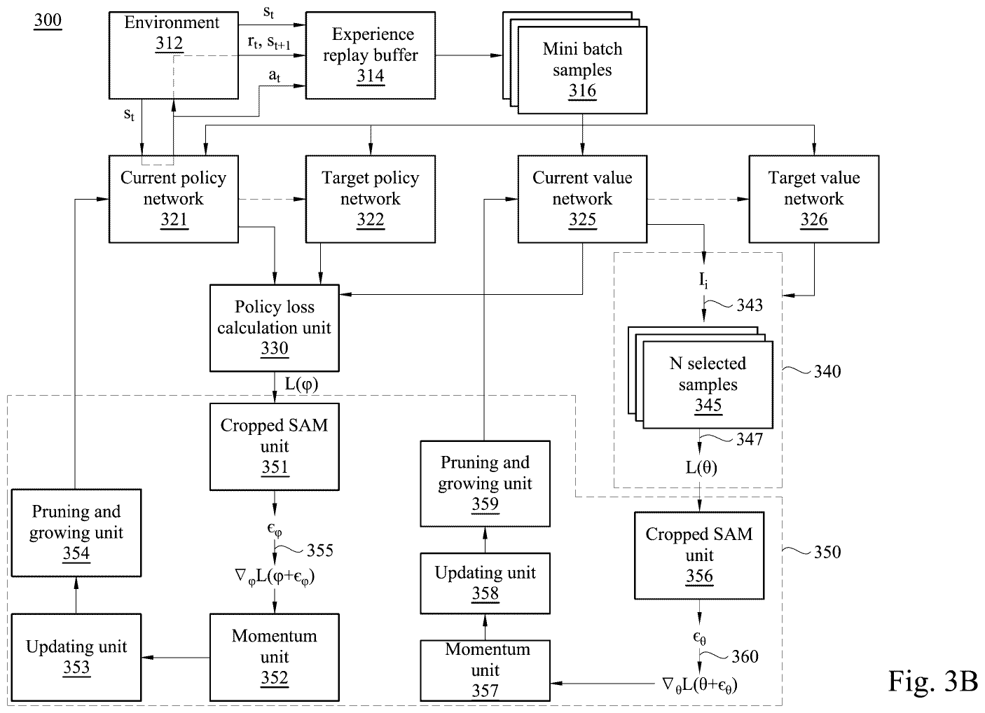

A description is provided with reference to FIG. 3A and FIG. 3B. FIG. 3A and FIG. 3B depict schematic diagrams of a lifelong deep reinforcement learning model 300 updated in each time step according to some embodiments of the present disclosure. In some embodiments, the lifelong deep reinforcement learning model 300 is illustrated as a deep deterministic policy gradient. To be noted that, the lifelong deep reinforcement learning model 300 can be implemented by the other model, such as, Q-learning, deep learning network, twin-delayed deep deterministic policy gradient or other off-policy models/algorithms. In some embodiments, the sparse training-cropped SAM with momentum optimizer 350 of the present disclosure can be applied to the aforesaid lifelong deep reinforcement learning model. Therefore, it is not intend to limit the present disclosure.

As show in FIG. 3A, the lifelong deep reinforcement learning model 300 includes an experience replay buffer 314, a sparse agent 320, a policy loss calculation unit 330, a value loss calculation unit 340 and a sparse training-cropped SAM with momentum optimizer 350. In some embodiments, the sparse agent 320 corresponds to any of sparse agents θ₁˜θₙ in FIG. 1. In some embodiments, the sparse agent 320 includes a current policy network 321, a target policy network 322, a current value network 325 and a target value network 326. In some embodiments, the current policy network 321 and the current value network 325 are current neural networks, and the target policy network 322 and the target value network 326 are target neural networks. In some embodiments, each of the current policy network 321, the target policy network 322, the current value network 325 and the target value network 326 included in the sparse agent 320 is a sparse neural network which includes Y % unmasked weights and (1-Y) % masked weights. In some embodiments, the sparse topology of the said sparse neural network can be expressed by a binary mask.

In some embodiments, the current policy network 321 generates an action at in a current time step according to a state sₜ associated with the environment 312, such that the sparse agent 320 executes the action aₜ, and the environment 312 generates a reward rₜ and a next state sₜ₊₁ in a next time step according to the action aₜ. In some embodiments, the state sₜ, the action aₜ, the reward rₜ and the next state sₜ₊₁ can be considered as a sample (or an experience tuple) which can be stored in experience replay buffer 314.

In some embodiments, the mini batch samples 316 are obtained from the experience replay buffer 314 as candidate samples. In some embodiments, the experience replay buffer 314 is a priority experience replay buffer. In some embodiments, the weight given to each sample stored in the experience replay buffer 314 is given by the following function.

$${ω}_{i} = \frac{1}{max ( max ( {c}_{min} , N \times η ) , i )} - \frac{1}{N}$$

In some embodiments, the term ωᵢ refers to the weight given to i-th sample. The term cₘᵢₙ refers to a hyperparameter. The term N refers to a size of the experience replay buffer 314 (or the number of samples stored in the experience replay buffer 314). The term n refers to a coefficient. The term i refers to the order in which the i-th sample is stored in experience replay buffer 314, and the term I can be considered as any integer in a range of 1˜N. In the above function, the samples which are earlier stored in experience replay buffer 314 are given with greater weights, and the samples which are stored in experience replay buffer 314 later are given with smaller weights. In some embodiments, a probability of the i-th sample can be calculated according to the weights of the N samples stored in the experience replay buffer 314, and the said probability is given by the term ωr′ᵢ in the following function.

$${ω}_{i}^{′} = \frac{{ω}_{i}}{{\sum }_{i = 1}^{N} {ω}_{i}}$$

As a result, the probabilities of all the samples being sampled from the experience replay buffer 314 can be obtained. In some embodiments, the number of the mini batch samples 316 can be expressed by Nₘᵢₙᵢ. In some embodiments, a portion (such as, z*Nₘᵢₙᵢ, where the term z is a decimal number in a range of 0˜1) of the mini batch samples 316 is sampled according to the probabilities of N samples from the experience replay buffer 314, and the other portion (such as, (1−z)*Nₘᵢₙᵢ) of the mini batch samples 316 is randomly sampled from the experience replay buffer 314.

In some embodiments, the current policy network 321 with weight parameters φ can be parameterized as P_{φ}, and the target policy network 322 with weight parameters φ_{targ} can be parameterized as P_{φ}_{_{targ}}.

In some embodiments, the current value network 325 with parameters e can be parameterized as a function Q_{θ}, and the target value network 326 with parameters θ_{targ} can be parameterized as a function Q_{θ}_{_{targ}}.

In some embodiments, the policy loss calculation unit 330 is referred to a policy loss function L(φ). In some embodiments, the policy loss function L(φ) is given by the following function.

$$L ( ϕ ) = \frac{1}{\vert {N}_{select} \vert} {\sum }_{s ϵ {N}_{s e l e c t}} {Q}_{ϕ} ( s , {P}_{φ} ( s ) )$$

In the above formula, the term N_{select} refers to the selected samples from the mini batch samples 316. The term P_{φ}(s) refers to a deterministic policy which can give an action to the maximized the term Q_{ϕ}(s, a). In some embodiments, Q-function can be treated as a constant here.

In some embodiments, the sparse training-cropped SAM with momentum optimizer 350 calculates the gradients of the policy loss function L(φ) with respect to the weights of the current policy network 321, and performs gradient clipping on the gradients to obtain adjusted gradients, thereby updating the current policy network according to the adjusted gradients.

In some embodiments, the value loss calculation unit 340 can be referred to a value loss function L(θ). As shown in FIG. 3B, the value loss calculation unit 340 includes a secondary sampling operation 343 and a value loss calculation operation 347. In some embodiments, the value loss calculation unit 340 performs importance calculation on the mini batch samples 316. The importance calculation is given by the following functions.

$${I}_{i} = \frac{{\hat{L}}_{i} ( {Q}_{θ} ( {s}_{i} , {a}_{i} ) , {Q}_{{θ}_{t a r g}} ( {s}_{i + 1} , {a}_{i + 1} ) )}{{\sum }_{i = 1}^{{N}_{mini}} {\hat{L}}_{i} ( {Q}_{θ} ( {s}_{i} , {a}_{i} ) , {Q}_{{θ}_{t a r g}} ( {s}_{i + 1} , {a}_{i + 1} ) )}$$

$${\hat{L}}_{i} ( {Q}_{θ} ( {s}_{i} , {a}_{i} ) , {Q}_{{θ}_{t a r g}} ( {s}_{i + 1} , {a}_{i + 1} ) ) = \vert {Q}_{θ} ( {s}_{i} , {a}_{i} ) - {Q}_{{θ}_{t a r g}} ( {s}_{i + 1} , {a}_{i + 1} ) \vert$$

In the above formula, the term It refers to the importance of the i-th sample. The term Q_{θ}(sᵢ, aᵢ) refers to a predicted value given by the current value network 325 according to the state sᵢ and the action aᵢ of the i-th sample. The term Q_{θ}_{_{targ}}(sᵢ₊₁, aᵢ₊₁) refers to a evaluated value given by the target value network 326 according to the state sᵢ₊₁ of the i-th sample, and the action aᵢ₊₁ is generated by the target policy network 322 according to the sate sᵢ₊₁. In some embodiments, the state sᵢ₊₁ in the next time step is generated by the environment according to the action aᵢ, and the loss \hat{L}ᵢ(Q_{θ}(sᵢ, aᵢ), Q_{θ}_{_{targ}}(sᵢ₊₁, aᵢ₊₁)) can be considered as a temporal difference error, which can be referred to an error or a temporal difference.

In some embodiments, in a secondary sampling operation 343, the samples in the mini batch samples 316 are sort in descending order according to the importance of the mini batch samples 316. For example, the greater the loss \hat{L}ᵢ, the more important it is. On the other hand, the smaller the loss \hat{L}ᵢ, the less important it is. The top N samples (which are more important) in the order are selected as selected samples 345, where the said N with respect to the number of mini batch samples 316 can be a predetermined ratio. In some embodiments, the said ratio can be a value in a range of 45%˜55%. In some embodiments, the said ratio can be 50% or other appropriate value. In some embodiments, the number of the selected samples 345 can be expressed by Nₘᵢₙᵢ.

In some embodiments, in the value loss calculation operation 347, the value loss function L(θ) is given by the following functions.

$$L ( θ ) = {\sum }_{i = 1}^{{N}_{mini}} {C}_{j} {L}_{j} ( {Q}_{θ} ( {s}_{i} , {a}_{i} ) , {Q}_{{θ}_{targ}} ( {s}_{i + 1} , {a}_{i + 1} ) )$$

$${C}_{j} = \frac{( \frac{1}{{N}_{mini}} {\sum }_{i = 1}^{{N}_{mini}} {\hat{L}}_{i} ( {Q}_{θ} ( {s}_{i} , {a}_{i} ) , {Q}_{{θ}_{targ}} ( {s}_{i + 1} , {a}_{i + 1} ) ) )}{{\hat{L}}_{j} ( {Q}_{θ} ( {s}_{i} , {a}_{i} ) , {Q}_{{θ}_{targ}} ( {s}_{i + 1} , {a}_{i + 1} ) )}$$

$${L}_{j} ( {Q}_{θ} ( {s}_{i} , {a}_{i} ) , {Q}_{{θ}_{targ}} ( {s}_{i + 1} , {a}_{i + 1} ) ) = {( {Q}_{θ} ( {s}_{i} , {a}_{i} ) - {Q}_{{θ}_{targ}} ( {s}_{i + 1} , {a}_{i + 1} ) )}^{2}$$

In the above formula, the value loss function L(θ) includes a square of the temporal difference error. In some embodiments, the value loss function L(θ) includes a weight Cⱼ which is used to weight the loss Lⱼ, in order to balance the proportion of the loss of each sample in the overall loss function.

In some embodiments, the sparse training-cropped SAM with momentum optimizer 350 calculates the gradients of the value loss function L(θ) with respect to the weights included in the current value network 325, and performs gradient clipping on these gradients to obtain the adjusted gradients, in order to update the current value network 325 according to the adjusted gradients.

As shown in FIG. 3B, the sparse training-cropped SAM with momentum optimizer 350 includes cropped SAM units 351 and 356, momentum units 352 and 357, weight updating units 353 and 358 and pruning and growing units 354 and 359. In the embodiments of the present disclosure, it is illustrates (dual) actor-critic architecture for example, thus the sparse training-cropped SAM with momentum optimizer 350 respectively optimizes two loss functions (such as, the policy loss function and the value loss function). In the other embodiments, depending on the number of the loss functions in a model, the sparse training-cropped SAM with momentum optimizer 350 can optimize one or more loss function, which is not intended to limit the present disclosure.

In some embodiments, the cropped SAM unit 351 performs the gradient clipping on the gradients of the policy loss function L(φ), and then the loss sharpness minimization can be performed on the clipped gradients (adjusted gradients). In some embodiments, the gradient clipping performed on the gradient of the policy loss function L(φ) is given by the following functions.

$${∇}_{ϕ} {L ( ϕ ⊙ {M}_{ϕ} )}^{′} = min ( \frac{c}{‖ {∇}_{ϕ} L ( ϕ ⊙ {M}_{ϕ} ) ‖} , 1 ) {∇}_{ϕ} L ( ϕ ⊙ {M}_{ϕ} )$$

In the above formula, the term ∇_{ϕ}L(ϕ⊙M_{ϕ})′ refers to a clipped gradient (adjusted gradient). The term c refers to a hyperparameter. The term M_{ϕ} refers to a binary mask for masking the weights in the current policy network 321, which also refers to a sparse topology of the current policy network 321. The element ⊙ refers to an element-wise multiplication operator.

In some embodiments, the loss sharpness minimization is given by the following function.

$${min}_{ϕ} {max}_{{‖ {ϵ}_{ϕ} ‖}_{2} \leq ρ} L ( ϕ + {ϵ}_{ϕ} )$$

In the above formula, the term ϵ_{ϕ} refers to a perturbation vector given to the weight parameter. The above said function means that the maximum loss is minimized in the neighborhood of ρ, it is to find a weight parameter ϕ in a flat local minimum in a parameter space. In some embodiments, the perturbation vector ϵ_{ϕ} is given by the following function.

$${ϵ}_{ϕ} = {arg max}_{{‖ {ϵ}_{ϕ} ‖}_{2} \leq ρ} L ( ( ϕ + {ϵ}_{ϕ} ) ) \sim \frac{ρ}{{‖ {∇}_{ϕ} {L ( ϕ ⊙ {M}_{ϕ} )}^{′} ‖}_{2}} {∇}_{ϕ} {L ( ϕ ⊙ {M}_{ϕ} )}^{′}$$

As a result, the perturbation vector ϵ_{ϕ} can be calculated according to the clipped gradient (which refers to ∇_{ϕ}L(ϕ⊙M_{ϕ})′), in order to avoid that the gradient explosion, causing from the task which has large differences from the previous tasks, occurs in the loss sharpness minimization.

In some embodiments, in the operation 355, the SAM gradient∇_{ϕ}L(φ+ϵ_{ϕ}) is calculated according to the policy loss function L(φ) and the perturbation vector ϵ_{ϕ}.

In some embodiments, the momentum unit 352 is configured to consider updates to the weight parameters φ in a prior time step, thereby calculating updates to the weight in the current time step according to the updates to the weight parameters φ in the prior time step, the policy loss function L(φ) and the perturbation vector ϵ_{ϕ}. In some embodiments, the updates to the unmasked weight of the current policy network 321 are given by the following function.

$${v}_{t} ← κ \cdot {v}_{t - 1} + {∇}_{φ} L ( φ + {ϵ}_{ϕ} )$$

In the above formula, the term vₜ refers to an update to a weight in a current time step. The term κ refers to inertia constant. The term vₜ₋₁ refers to an update to the weight in a prior time step.

In some embodiments, the weight updating unit 353 is given by the following function.

$$φ ← φ - η \cdot {v}_{t}$$

In the above formula, the weight parameters φ of the current policy network can be updated with (φ−η·vₜ), where the term n is a learning rate. As a result, the weights included in the current policy network 321 can be updated.

In some embodiments, the pruning and growing unit 354 includes functions of pruning and growing weight, which are given by the following binary masks (the sparse topologies).

$${M}_{φ} ← {M}_{φ} - 1 ( - \vert ∇ L ( φ ) \vert , N drop )$$

$${M}_{φ} ← {M}_{φ} + 1 ( Random , N drop )$$

In the above formula, the values −|∇L(φ)| of the weight parameters φ are sorted in order, and the last N weight parameters in the order, which have the smaller values −|∇L(φ)|, are removed, thereby randomly growing the same number weight parameters.

In some embodiments, the pruning and growing unit 354 further includes functions of pruning and growing perturbation, which are given by the following binary masks (the perturbation topologies).

$${M}_{{ϵ}_{ϕ}} ← {M}_{{ϵ}_{ϕ}} - 1 ( - \vert ∇ L ( {ϵ}_{ϕ} ) \vert , N drop )$$

$${M}_{{ϵ}_{ϕ}} ← {M}_{{ϵ}_{ϕ}} + 1 ( Random , N drop )$$

In the above formula, the values −|∇L(ϵ)| of the perturbation vectors are sorted in order, and the last N perturbation vectors in the order, which have the smaller values −|∇L(ϵ)| are removed, thereby randomly growing the same number perturbation vectors.

As a result, the parse topology and the perturbation topology of the current policy network 321 can be updated with the updated sparse topology and the updated perturbation topology.

In some embodiments, the cropped SAM unit 356 performs the gradient clipping on the gradients of the policy loss function L(θ), and then the loss sharpness minimization can be performed on the clipped gradients (adjusted gradients). In some embodiments, the gradient clipping performed on the gradient of the policy loss function L(θ) is given by the following functions.

$${∇}_{θ} {L ( θ ⊙ {M}_{θ} )}^{′} = min ( \frac{c}{‖ {∇}_{θ} L ( θ ⊙ {M}_{θ} ) ‖} , 1 ) {∇}_{θ} L ( θ ⊙ {M}_{θ} )$$

In the above formula, the term ∇_{θ}L(θ⊙M_{θ})′ refers to a clipped gradient (adjusted gradient). The term c refers to a hyperparameter. The term M_{θ} refers to a binary mask for masking the weights in the current value network 325, which also refers to a sparse topology of the current value network 325. The element ⊙ refers to an element-wise multiplication operator. In some embodiments, the element min ( ) is a minimum operator.

In some embodiments, the loss sharpness minimization is given by the following function.

$${min}_{θ} {max}_{{‖ {ϵ}_{θ} ‖}_{2} \leq ρ} L ( θ + {ϵ}_{θ} )$$

In the above formula, the term ϵ_{θ} refers to a perturbation vector given to the weight parameters θ. The above said function means that the maximum loss is minimized in the neighborhood of ρ, it is to find a weight parameter ϕ in a flat local minimum in a parameter space. In some embodiments, the perturbation vector ϵ_{θ} is given by the following function.

$${ϵ}_{θ} = {arg max}_{{‖ {ϵ}_{ϕ} ‖}_{2} \leq ρ} L ( ( θ + {ϵ}_{θ} ) ) \sim \frac{ρ}{{‖ {∇}_{θ} {L ( θ ⊙ {M}_{θ} )}^{′} ‖}_{2}} {∇}_{θ} {L ( θ ⊙ {M}_{θ} )}^{′}$$

As a result, the perturbation vector ϵ_{θ} can be calculated according to the clipped gradient (which refers to ∇_{θ}L(θ⊙M_{θ})′), in order to avoid that the gradient explosion, causing from the task which has large differences from the previous tasks, occurs in the loss sharpness minimization.

1 In some embodiments, in the operation 360, the SAM gradient ∇_{θ}L(θ+ϵ_{θ}) is calculated according to the value loss function L(θ) and the perturbation vector ϵ_{θ}.

In some embodiments, the momentum unit 357 is configured to consider updates to the weight parameters θ in a prior time step, thereby calculating updates to the weight in the current time step according to the updates to the weight parameters θ in the prior time step, the policy loss function L(θ) and the perturbation vector ϵ_{θ}. In some embodiments, the updates to the unmasked weight of the current value network 325 are given by the following function.

$${v}_{t} ← κ \cdot {v}_{t - 1} + {∇}_{θ} L ( θ + {ϵ}_{θ} )$$

In the above formula, the term vₜ refers to an update to a weight in a current time step. The term κ refers to inertia constant. The term vₜ₋₁ refers to an update to the weight in a prior time step.

In some embodiments, the weight updating unit 358 is given by the following function

$$θ ← θ - η \cdot {v}_{t}$$

In the above formula, the weight parameters θ of the current value network 32 can be updated with (θ−η·vₜ), where the term n is a learning rate. As a result, the weights included in the current value network 325 can be updated.

In some embodiments, the pruning and growing unit 359 includes functions of pruning and growing weight, which are given by the following binary masks (the sparse topologies).

$${M}_{θ} ← {M}_{θ} - 1 ( - \vert ∇ L ( θ ) \vert , N drop )$$

$${M}_{θ} ← {M}_{θ} + 1 ( Random , N drop )$$

In the above formula, the values −|∇L(θ)| of the weight parameters θ are sorted in order, and the last N weight parameters in the order, which have the smaller values −|∇L(θ)|, are removed, thereby randomly growing the same number weight parameters.

In some embodiments, the pruning and growing unit 359 further includes functions of pruning and growing perturbation, which are given by the following binary masks (the perturbation topologies).

$${M}_{{ϵ}_{θ}} ← {M}_{{ϵ}_{θ}} - 1 ( - \vert ∇ L ( θ ) \vert , N drop )$$

$${M}_{{ϵ}_{θ}} ← {M}_{{ϵ}_{θ}} + 1 ( Random , N drop )$$

In the above formula, the values −|∇L(θ)| of the perturbation vectors are sorted in order, and the last N perturbation vectors in the order, which have the smaller values −|∇L(θ)| are removed, thereby randomly growing the same number perturbation vectors.

As a result, the parse topology and the perturbation topology of the current policy network 321 can be updated with the updated sparse topology and the updated perturbation topology.

In some embodiments, the current policy network 321 and the current value network 325 respectively soft update the target policy network 322 and the target value network 326 every M steps (such as, every two steps).

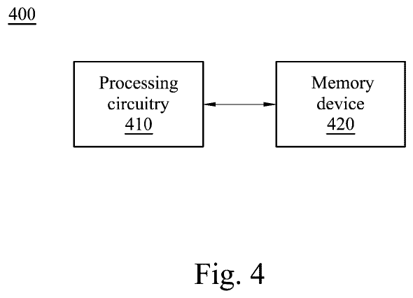

A description is provided with reference to FIG. 4. FIG. 4 depicts a schematic diagram of a training system 400 according to some embodiments of the present disclosure. As show in FIG. 4, the training system 400 includes a processing circuitry 410 and a memory device 420. In some embodiments, the memory device 420 can be a non-transitory computer readable media. The memory device 420 is configured to store data (such as, the lifelong deep reinforcement learning model 300) and computer executable instructions. In some embodiments, the memory device 420 can include a dynamic memory, static memory, hard disk and/or flash memory. In some embodiments, the processing circuitry 410 is electrically coupled to the memory device 420, and the processing circuitry 410 is configured to access the data or instructions stored in the memory device 420 to execute the method 200 in FIG. 2A to FIG. 2B, the reinforcement learning model 100 in FIG. 1 and/or the lifelong deep reinforcement learning model 300 in FIG. 3A to FIG. 3B. In some embodiments, the processing circuitry 410 includes a central processing unit, graphic processing unit, tensor processing unit, application specific integrated circuit or any equivalent e processing circuitry.

Summary, the training method of the present disclosure utilizes sharpness awareness minimization calculation to improve the generalization ability. Furthermore, the present disclosure includes the gradient clipping operation before the sharpness awareness minimization calculation, which can avoid a gradient explosion occurs in sharpness awareness minimization calculation due to the variances between tasks. In addition, the priority experience replay buffer can avoid catastrophic forgetting.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A training method, wherein in each time step in one or more episode, the training method comprising:
generating an action, by a sparse agent, according to a state; and
obtaining a plurality of candidate samples from an experience replay buffer to update a current neural network of the sparse agent, and wherein step of updating the current neural network comprises:
calculating a loss function according to the candidate samples;
calculating a plurality of gradients of the loss function with respect to a plurality of weights;
performing gradient clipping on the gradients to generate a plurality of adjusted gradients;
performing sharpness awareness minimization calculation according to the adjusted gradients, to obtain a plurality of perturbation vectors; and
updating the current neural network according to the loss function and the perturbation vectors, to generate an updated neural network.

2. The training method of claim 1, wherein the current neural network is a sparse neural network.

3. The training method of claim 2, wherein the sparse neural network comprises a plurality of masked weights and a plurality of unmasked weights, wherein the weights are unmasked weights.

4. The training method of claim 1, wherein step of updating the current neural network to generate the updated neural network comprises:
updating the weights of the current neural network according to the loss function and the perturbation vectors, to obtain a plurality of updated weights;
updating a sparse topology of the current neural network according to the gradients, to obtain an updated sparse topology;
updating a perturbation topology of the current neural network according to the gradients, to obtain an updated perturbation topology; and
updating the current neural network according to the updated weights, the updated sparse topology and the updated perturbation topology, to obtain the updated neural network.

5. The training method of claim 4, wherein:
the updated sparse topology is configured to prune a portion of the updated weights and grow same number of new weights; and
the updated perturbation topology is configured to prune a portion of the perturbation vectors and grow same number of perturbation vectors.

6. The training method of claim 1, wherein step of generating the updated neural network comprises:
updating the weights of the current neural network according to the loss function, the perturbation vectors and a plurality of updates to the weights in a prior time step, to obtain a plurality of updated weights.

7. The training method of claim 1, wherein in an initialization stage, the training method comprises:
obtaining a dense model with random parameters;
interacting with an environment based on the dense model to generate a plurality of samples, and storing the samples in the experience replay buffer; and
initializing a sparse topology and a perturbation topology based on the dense model, to obtain an initialized neural network.

8. The training method of claim 1, wherein step of obtaining the candidate samples comprises:
calculating a plurality of probabilities of samples according to a priority order of a plurality of samples stored in the experience replay buffer;
sampling a portion of the candidate samples according to the probabilities of samples; and
randomly sampling the other portion of the candidate samples from the experience replay buffer.

9. The training method of claim 1, wherein step of calculating the loss function comprises:
calculating a plurality of importances of the candidate samples according to a plurality of errors of the candidate samples between outputs of a current value network and a target value network;
selecting a portion of the candidate samples according to the importances;
calculating a plurality of temporal difference errors of the candidate samples; and
weighting the temporal difference errors to calculate the loss function.

10. The training method of claim 1, further comprising:
if the one or more episode is not over, updating the updated neural network in a next time step; and
in the next time step, obtaining a reward and a next state generated by an environment according to the action, and storing the state, the action, the reward and the next state as a new sample in the experience replay buffer.

11. The training method of claim 1, wherein the sparse agent is configured to interact with an environment in the one or more episode to execute a first task.

12. The training method of claim 11, further comprising:
duplicating the sparse agent to generate a duplicated sparse agent, and wherein the duplicated sparse agent interacts with the environment in one or more episode to execute a second task which is different from the first task.

13. A training system, comprising:
a memory device, configured to store a plurality of instructions and data; and
a processing circuitry, configured to access the memory device to execute following steps in one or more episode:
generate a current action, by a sparse agent, according to a current state; and
obtain a plurality of candidate samples from an experience replay buffer to update a current neural network of the sparse agent, and the processing circuitry is further configured to execute following steps in step of updating the current neural network:
calculate a loss function according to the candidate samples;
calculate a plurality of gradients of the loss function with respect to a plurality of weights;
perform gradient clipping on the gradients to generate a plurality of adjusted gradients;
perform sharpness awareness minimization calculation according to the adjusted gradients, to obtain a plurality of perturbation vectors; and
update the current neural network according to the loss function and the perturbation vectors, to generate an updated neural network.

14. The training system of claim 13, wherein the current neural network is a sparse neural network.

15. The training system of claim 14, wherein the sparse neural network comprises a plurality of masked weights and a plurality of unmasked weights, and wherein the weights are unmasked weights.

16. The training system of claim 13, wherein the processing circuitry is further configured to:
update the weights of the current neural network according to the loss function and the perturbation vectors, to obtain a plurality of updated weights;
update a sparse topology of the current neural network according to the gradients, to obtain an updated sparse topology;
update a perturbation topology of the current neural network according to the gradients, to obtain an updated perturbation topology; and
update the current neural network according to the updated weights, the updated sparse topology and the updated perturbation topology, to obtain the updated neural network.

17. The training system of claim 16, wherein:
the updated sparse topology is configured to prune a portion of the updated weights and grow same number of new weights; and
the updated perturbation topology is configured to prune a portion of the perturbation vectors and grow same number of perturbation vectors.

18. The training system of claim 13, wherein the processing circuitry is further configured to:
update the weights of the current neural network according to the loss function, the perturbation vectors and a plurality of updates to the weights in a prior time step, to obtain a plurality of updated weights.

19. The training system of claim 13, wherein in an initialization stage, the processing circuitry is further configured to:
obtain a dense model with random parameters;
interact with an environment based on the dense model to generate a plurality of samples, and storing the samples in the experience replay buffer; and
initialize a sparse topology and a perturbation topology based on the dense model, to obtain an initialized neural network.

20. A non-transitory computer-readable media, comprising a plurality of instructions and data accessed by a processing circuitry to execute:
generate a current action, by a sparse agent, according to a current state; and
obtain a plurality of candidate samples from an experience replay buffer to update a current neural network of the sparse agent, and step of updating the current neural network comprises:
calculate a loss function according to the candidate samples;
calculate a plurality of gradients of the loss function with respect to a plurality of weights;
perform gradient clipping on the gradients to generate a plurality of adjusted gradients;
perform sharpness awareness minimization calculation according to the adjusted gradients, to obtain a plurality of perturbation vectors; and
update the current neural network according to the loss function and the perturbation vectors, to generate an updated neural network.
